(19) United States
(12) Patent Application Publication
(10) Pub. No.: US 2005/0288066 A1
(43) Pub. Date: Dec. 29, 2005

(54) Network support for location of called mobile subscriber

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: CARMEN B. PATTI & ASSOCIATES, LLC, ONE NORTH LASALLE STREET, 44TH FLOOR, CHICAGO, IL, 60602, US

(21) Appl. No.: 10/876,408

(22) Filed: Jun. 25, 2004

(51) Int. Cl. H04Q 7/20

(52) U.S. Cl. 455/566

(57) ABSTRACT

Embodiments of the system and method provide for network support for location information display of a mutually agreeable list of called mobile terminals, even if a called mobile terminal does not answer a call. One embodiment of the method may have the steps of: forming a group of mobile terminals in a network; calling, by a calling terminal, at least one called mobile terminal that is a member of the group of mobile terminals; retrieving, via the network, location information for the called mobile terminal; and displaying at least the retrieved location information at the calling terminal, irrespective of whether of not the call placed to the called mobile terminal is answered

### TECHNICAL FIELD

The present invention relates generally to telecommunication, and in particular for a network to support a location information display of a mutually agreeable list of called mobile subscribers, even if a called party does not answer a call.

### BACKGROUND OF THE INVENTION

Wireless communication systems are constantly evolving. System designers are continually developing greater numbers of features for both service providers as well as for the end users. In the area of wireless phone systems, cellular based phone systems have advanced tremendously in recent years. Wireless phone systems are available based on a variety of modulation techniques and are capable of using a number of allocated frequency bands. Available modulation schemes include analog FM and digital modulation schemes using Time Division Multiple Access (TDMA) or Code Division Multiple Access (CDMA). Each scheme has inherent advantages and disadvantages relating to system architecture, frequency reuse, and communications quality. However, the features the manufacturer offers to the service provider and which the service provider offers to the consumer are similar between the different wireless systems.

Regardless of the modulation scheme in use, the wireless phone available to the end user has a number of important features. Nearly all wireless phones incorporate at least a keyboard for entering numbers and text, and a display that allows the user to display text, dialed numbers, pictures and incoming caller numbers. Additionally, wireless phones may incorporate electronic phonebooks, speed dialing, single button voicemail access, and messaging capabilities, such as e-mail.

Although prior art cell phones have many features, there are still certain features that are very important but that are not available. It is well known that today many people have their children carry cell phones. However, if a call is not answered the parents have no idea where the child is presently located. If available, such location information could be used to verify the whereabouts of the child when placing a call to their mobile phone. Therefore, this is significant drawback of the prior art.

### SUMMARY

The invention in one implementation encompasses a system that provides network support for location information display of a mutually agreeable list of called mobile terminals, even if a called mobile terminal does not answer a call. One embodiment of the system may have: a group of at least one mobile terminal operatively connected to a network; a calling terminal operatively connected to the network; a locator module in the network, the locator module determining location information of a called mobile terminal that is a member of the group of mobile terminals, the called mobile terminal being called by the calling terminal; wherein at least the retrieved location information is displayed at the calling terminal, irrespective of whether of not the call placed to the called mobile terminal is answered.

Another implementation of the present invention encompasses a method that may have the steps of: forming a group of mobile terminals in a network; calling, by a calling terminal, at least one called mobile terminal that is a member of the group of mobile terminals; retrieving, via the network, location information for the called mobile terminal; and displaying at least the retrieved location information at the calling terminal, irrespective of whether of not the call placed to the called mobile terminal is answered.

### BRIEF DESCRIPTION OF THE DRAWINGS

Features of exemplary implementations of the invention will become apparent from the description, the claims, and the accompanying drawings in which:

FIG. 1 depicts a block diagram that illustrates elements of a system according to one embodiment for providing a network that supports a location information display of a mutually agreeable list of called mobile subscribers, even if a called party does not answer a call.

FIG. 2 illustrates a very general flow chart of logical operational steps that may be followed in accordance with one embodiment of the present method and system.

### DETAILED DESCRIPTION

The particular values and configurations discussed in these non-limiting examples can be varied and are cited merely to illustrate an embodiment of the present invention and are not intended to limit the scope of the invention.

In one embodiment of the system and method, the intent of this feature is for the network to retrieve the location of the called party (also referred to as a mobile terminal, mobile phone, cell phone, etc.) using one of the following methods: a GPS system, and a triangulation process amongst cell sites that a mobile terminal is communicating with in order to give the calling party a location description display of the called mobile subscriber.

In embodiments of the system and method this feature would be in effect for only certain group of wireless subscribers, who would have the option to join or leave a location group as they wished or set a time limit on their inclusion in the group. In one example, a parent could pre-define the mobile numbers of each of his/her teenage children to support location reporting of the called party back to the calling party's phone. This location information could be used to verify the whereabouts of a child when placing a call to their mobile phone. Note that the group of wireless subscribes may or may not include wired subscribers. In another example, a group of people visiting New York City could decide to form a location group and as they split up for the day they would be able to track each others whereabouts and adjust their plans accordingly.

Although the present system and method may be used with any type of network (wired and wireless, for example), a subscriber may typically be a mobile subscriber who uses a mobile terminal (also referred to as mobile phone, a cell phone, mobile handset, or car phone).

A methodology for mobile subscribers to allow other mobile subscriber's who may be calling them to display their (the called subscriber's) location information on the calling party's phone when the call was connected, whether or not the called party answered the phone. Subscribers who allow another subscriber to view their location when being called are joining what could be called a “location group”.

Another methodology is for the network to retrieve the called subscriber location information using a GPS (Global Positioning System) locator (if the called party has a GPS-enabled mobile) and displaying a location identifier to the calling party.

A further methodology is for the network to retrieve location coordinates for the called party using a triangulation method amongst the cell sites that the mobile is communicating with (if the called party does not have a GPS enabled mobile) and displaying a location identifier to the calling party in addition to the calling number identifier.

Yet another methodology is for the network to support a new type of “location report” call, in which the calling subscriber places a request to obtain for the location information of another mobile subscriber in his or her location group and the information is returned, without even ringing the called parties phone.

A further methodology is for the network to display a location identifier for those called numbers that are part of a location group to a calling party that is also part of the same group.

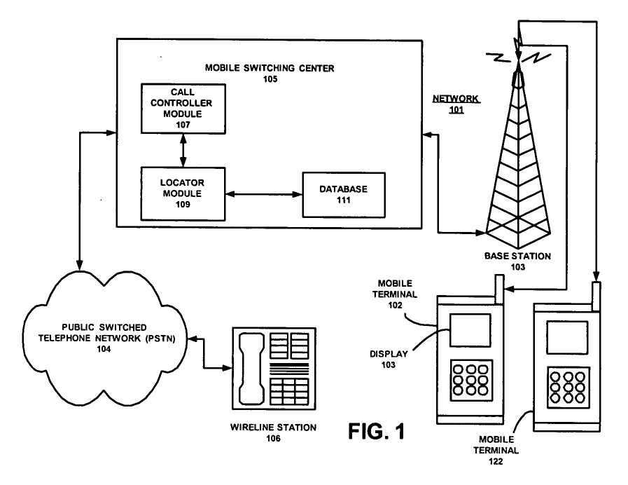

In the FIG. 1 embodiment a network 101 is operatively connected to at least one mobile terminal 102. As is known the network 101 may have at least one base station 103, which is operatively connected to a mobile switching center 105, wirelessly coupled to mobile terminal 102 and 122. The mobile switching center 105 in the network 101 may also have a call control module 107 operatively connected to base station 103 and to a locator module 109. A database 111 may also be operatively connected to the locator module 109.

The network 101 may be, or may be part of, one or more of a telephone network, a local area network (“LAN”), the Internet, and a wireless network. In the depicted embodiment, a public switched telephone network (PSTN) 104 is connected to the mobile switching center 105. The PSTN 104 routes calls to and from mobile users through the mobile switching center 105. The PSTN 104 also routes calls from and to wireline stations 106. The PSTN 104 generally may be implemented as the worldwide voice telephone network accessible to all those with telephones and access privileges (e.g., AT&T long distance network).

The locator module 109 allows network support for location information display of a mutually agreeable list of called mobile subscribers, even if a called party does not answer a call.

In embodiments of the present method, mutually, consensual wireless subscribers may add one another's numbers to a predefined location group, such as mobile terminals 102 and 122. As a member of a group, the called party's location information may be displayed on a calling parties mobile terminal (such as the display 103 of the mobile terminal 102) if the calling party is also a member of the same location group. The calling party may then initiate a call to a mobile subscriber with location group display feature activated for the called wireless number. In response, the network may retrieve called party location information either through a GPS system, if available, or based on cell site location (such as triangulation). The network may then send location information (as well as other information that may be stored in the database 111, for example) to the calling party (such as mobile terminal 102) when the call is connected, whether or not the called party (such as mobile terminal 122) answers the call. The location information sent by the network to the calling party may be translated into something easily understood by the subscriber, such as a street address or intersection.

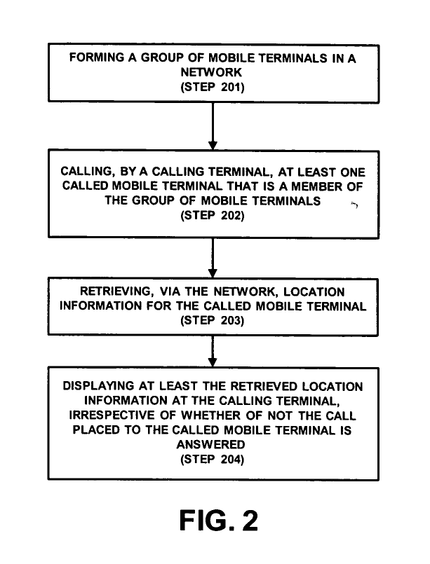

Referring to FIG. 2, one embodiment of a method for network support for location information display of a mutually agreeable list of called mobile terminals, even if a called mobile terminal does not answer a call, may have the steps of: forming a group of mobile terminals in a network (step 201); calling, by a calling terminal, at least one called mobile terminal that is a member of the group of mobile terminals (step 202); retrieving, via the network, location information for the called mobile terminal (step 203); and displaying at least the retrieved location information at the calling terminal, irrespective of whether of not the call placed to the called mobile terminal is answered (step 204).

Therefore, the improved present method and system overcomes the drawbacks of the prior art by providing for mobile subscribers, who are being called, the called subscriber's location information on the calling party's terminal when the call was connected, whether or not the called party answered the phone.

The present system and method may be used with non-mobile phones and terminals, as well as, mobile phones and mobile terminals. Also, different types of data storage devices may be used with the present method and system. For example, a data storage device may be one or more of a magnetic, electrical, optical, biological, and atomic data storage medium.

The steps or operations described herein are just exemplary. There may be many variations to these steps or operations without departing from the spirit of the invention. For instance, the steps may be performed in a differing order, or steps may be added, deleted, or modified.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for network support for location information display of a mutually agreeable list of called mobile terminals, even if a called mobile terminal does not answer a call, comprising the steps of:
forming a group of mobile terminals in a network;
calling, by a calling terminal, at least one called mobile terminal that is a member of the group of mobile terminals;
retrieving, via the network, location information for the called mobile terminal; and
displaying at least the retrieved location information at the calling terminal, irrespective of whether of not the call placed to the called mobile terminal is answered.

2. The method according to claim 1, wherein the calling terminal is a mobile terminal that is also a member of the group.

3. The method according to claim 1, wherein the calling terminal is a mobile terminal that is not a member of the group.

4. The method according to claim 1, wherein mobile terminals join and leave the group at any time.

5. The method according to claim 1, wherein the method further comprises retrieving a present location of the called mobile terminal by use of a global positioning system.

6. The method according to claim 1, wherein the method further comprises retrieving a present location of the called mobile terminal by use of a triangulation process.

7. The method according to claim 1, wherein the method further comprises storing at the network respective information for at least one mobile terminal that is a member of the group, and displaying the respective information at the calling terminal along with the location information for the called mobile terminal.

8. The method according to claim 1, wherein the method further comprises retrieving and displaying a present location of the called mobile terminal without producing a ringing of the called mobile terminal.

9. A system that provides network support for location information display of a mutually agreeable list of called mobile terminals, even if a called mobile terminal does not answer a call, comprising:
a group of at least one mobile terminal operatively connected to a network;
a calling terminal operatively connected to the network;
a locator module in the network, the locator module determining location information of a called mobile terminal that is a member of the group of mobile terminals, the called mobile terminal being called by the calling terminal;
wherein at least the retrieved location information is displayed at the calling terminal, irrespective of whether of not the call placed to the called mobile terminal is answered.

10. The system according to claim 9, wherein the calling terminal is a mobile terminal that is also a member of the group.

11. The system according to claim 9, wherein the calling terminal is a mobile terminal that is not a member of the group.

12. The system according to claim 9, wherein mobile terminals join and leave the group at any time.

13. The system according to claim 9, wherein the system further comprises a global positioning system for retrieving a present location of the called mobile terminal.

14. The system according to claim 9, wherein the method further comprises a triangulation process for retrieving a present location of the called mobile terminal.

15. The system according to claim 9, wherein the method further comprises a database in the network in which is stored respective information for at least one mobile terminal that is a member of the group, and a display on the calling terminal on which is displayed the respective information along with the location information for the called mobile terminal.

16. The system according to claim 9, wherein the system further comprises retrieving and displaying a present location of the called mobile terminal is retrieved and displayed without producing a ringing of the called mobile terminal.

17. A method for network support for location information display of a mutually agreeable list of called mobile terminals, even if a called mobile terminal does not answer a call, comprising the steps of:
forming a group of mobile terminals in a network;
calling, by a calling mobile terminal, at least one called mobile terminal that is a member of the group of mobile terminals;
retrieving, via the network, location information for the called mobile terminal using at least one of a global positioning system and a triangulation process; and
displaying at least the retrieved location information at the calling mobile terminal, irrespective of whether of not the call placed to the called mobile terminal is answered.

18. The method according to claim 17, wherein the method further comprises storing at the network respective information for at least one mobile terminal that is a member of the group, and displaying the respective information at the calling terminal along with the location information for the called mobile terminal.

19. The method according to claim 17, wherein the method further comprises retrieving and displaying a present location of the called mobile terminal without producing a ringing of the called mobile terminal.

20. The system according to claim 17, wherein mobile terminals join and leave the group at any time.
